(19) United States
(12) Patent Application Publication
(10) Pub. No.: US 2009/0292656 A1
(43) Pub. Date: Nov. 26, 2009

(54) METHOD, APPARATUS AND SYSTEM FOR COLLECTING, RECEIVING, AND DISTRIBUTING INFORMATION FROM MULTIPLE CHANNELS

(75) Inventors: Sreevatsan Raman, San Jose, CA (US); Anand Madhavan, Santa Clara, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/125,895

(22) Filed: May 22, 2008

(51) Int. Cl. G06N 5/02; G06F 17/00; G06F 3/01

(52) U.S. Cl. 706/11; 706/47

(57) ABSTRACT

Embodiments of methods, apparatuses, devices and systems associated with collecting, receiving, and distributing information from multiple channels of information are disclosed.

### FIELD

Claimed subject matter relates to the field of collecting, receiving, mining, filtering, ranking and distributing information.

### BACKGROUND

The internet provides access to a vast amount of information. Given the vast amount of information, various solutions have been made available to locate information that may be relevant for a particular user at a particular time. For example, a user may submit queries to a search engine or visit a particular web site to find desirable information. However, gathering information in this manner typically involves a user actively seeking out the information, and the information may still not be particularly relevant for a particular user. Furthermore, there may be desirable information to be had that may be difficult for a user to locate or access only via the internet. Efforts to make relevant information available to a user in a timely manner are accordingly ongoing.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a flow chart of a process in accordance with an embodiment;

FIG. 2 is a schematic diagram relating to one or more channels of information in accordance with an embodiment;

FIG. 3 is a schematic diagram of an apparatus in accordance with an embodiment; and

FIG. 4 is a schematic diagram of a system in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components or circuits that would be known by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

The terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

As an example some information may be provided in a manner partially customized for a particular user. For example, a web site may list local weather or news items for a particular user based at least in part on stored information associated with a particular user, such as a user's interests, world news, local news, or the user's social network activities. However, such systems may not offer much variety in the type, scope or channels of information such systems may make available to a user. Furthermore, it may be desirable for such systems to provide greater customization in the information such systems make available to a particular user.

For example, it may be advantageous for a system or process to collect information that may be at least partially disparate from a plurality of channels of information based at least in part on a set of user preferences. In addition, the channels of information may likewise be at least partially disparate. Furthermore, the collected information may also be parsed based at least in part on one or more rules. In an embodiment, such rules may be based at least in part on one or more explicit or implicit user preferences. In this context, user preferences means aspects or preferences of a user related to aspect of the transfer of information, including aspects of what is being transferred. For example, user preferences could specify type of information, sources of information, destinations for a transfer of information, modes through which a transfer of information may occur, times a transfer takes places, times at which a transfer begins, times at which a transfer ceases, and manners in which a transfer of information is initiated, of course these are only a few examples. For example, one or more user preferences may be derived by a system or process, based at least in part on the user's social network activity, a time of the day, a season of the year, an activity, one or more news items, a user's geographic location, or combinations thereof. However, it should be noted that these are merely examples of information that may be used to derive one or more user preferences and a variety of other information may likewise be used. Accordingly, claimed subject matter is not limited in this regard.

In one particular embodiment, a user preference may comprise a variety of types of information a user has selected to share with a system or process. The variety and scope of the types of information contemplated is only limited by the scope of how information is collected, received, distributed, and stored and it is intended that all such variety and scope is included within the scope of claimed subject matter. Examples of which may include information associated with one or more user devices, or application programs, such as contact information, calendar information, geographic information, search history information, shopping history information, or the like. Additional examples may include information from one or more web sites, such as shopping history information, social networking information, browsing history information, search history information, movie rental information, interests, or hobbies, to name but a few examples.

A system or process may use shared information at least in part to collect or receive at least partially disparate information from a plurality of channels of information. In an embodiment, a plurality of channels of information may comprise traffic information, weather information, information relating to restaurants, shopping, or entertainment, or from any other information a user has selected to share with, or receive from, the system or process, for example. For example, a user may choose to share a variety of types or channels of information. For example, a user may choose to share information from one or more application programs or user devices, such as contact information, calendar information, search information, shopping information or the like. In an embodiment, a user may choose to have an application program or device transmit shared information to a computing platform. In another embodiment, a user may provide a system or process with information, such as login information associated with an application program or device, at least in part to enable the system or process to obtain information from an application program. For an additional example, a user may choose to share information from one or more web sites, such as shopping sites, social networking sites, or other sites that may have information a user may decide to share with a system or process. In an embodiment, a user may instruct the one or more web sites to transmit shared information to a system or process. In another embodiment, a user may provide a system or process with information, such as login information associated with one or more web sites, at least in part to enable the system or process to obtain shared information from the one or more web sites.

In an embodiment, information from a plurality of channels of at least partially disparate information may be parsed based at least in part on one or more rules. For example, one or more rules may be based at least in part on explicit user preferences or implicit user preferences. In an embodiment, an explicit user preference may comprise one or more selections from a user relating to types, sources, time for delivery, etc. relating to information a user would like to receive or share. In an embodiment, implicit user preferences may be based at least in part on an analysis of one or more aspects of user behavior.

With regard to explicit user preferences, a user may select to receive traffic information at one or more times during a day, such as normal commute times for the user, for example. As another example, a user may select to share one or more types of information with a system or process, such as calendar information, contact information, social network information, or the like. As yet another example, a user may select to receive reminders for one or more people's birthdays and suggestions for stores that may have special deals or sales that may be of interest to the one or more people. As yet another example, a user may select to receive information relating to one or more news topics at one or more times throughout a day, such as stories or topics that may be of interest to the user.

In an embodiment, implicit user preferences may be based at least in part on one or more quantitative or qualitative aspects of the user's behaviors. In one particular embodiment, the system or process may analyze user behavior, such as intensity or frequency of on-line activity or searches and determine one or more rules based at least in part on that analysis. One example of analyzing user behavior may be found in U.S. patent application Ser. No. 11/130,592, entitled “Content-management system for user behavior targeting.” For example, if a user has recently been shopping for a particular product on-line, a system or process may determine that the user may be interested in sale advertisements for similar products from local or on-line retailers. However, it should be noted that these are merely examples relating to a system or process and that claimed subject matter is not limited in this regard.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “identifying,” “initiating,” “querying,” “obtaining,” “hosting,” “maintaining,” “representing,” “modifying,” “receiving,” “transmitting,” “storing”, “authenticating,” “authorizing,” “determining” or the like refer to the actions or processes that may be performed by a computing platform, such as a computer or a similar electronic computing device, that is operable to manipulate or transform data represented as physical, electronic or magnetic quantities or other physical quantities within the computing platform's processors, memories, registers, or other information storage, transmission, reception or display devices. Accordingly, a computing platform refers to a system or a device that includes the ability to process or store data in the form of signals. Thus, a computing platform, in this context, may comprise hardware, software, firmware or any combination thereof. Further, unless specifically stated otherwise, a process as described herein, with reference to flow diagrams or otherwise, may also be executed or controlled, in whole or in part, by a computing platform.

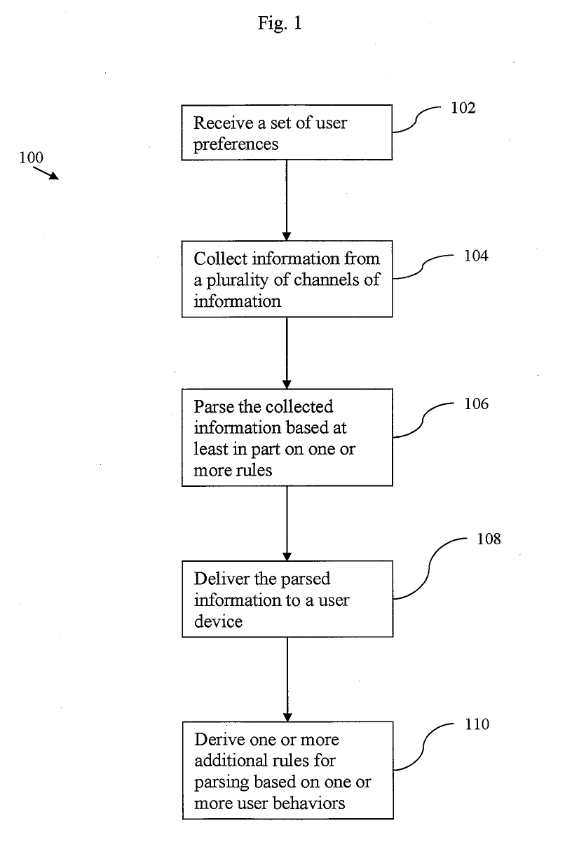

FIG. 1 is a flow chart of a method in accordance with an embodiment 100. With regard to box 102, a user may explicitly select to receive or share information relating to one or more categories, such as birthdays, traffic, weather, etc, one or more application programs, or one or more computing platforms and one or more user preferences, based at least in part on the selections, may be received, located, or obtained by a system or process in accordance with an embodiment. In an embodiment, a user may determine one or more preferences such as by selecting one or more options to determine what information associated with the user may be shared with a system or process. For example a user may choose to share information from one or more devices, application programs or third party sources, such as web sites, with a system or process. For example, a user may access a web site using a computing platform or an application program, such as an application program running on a computing platform. Using the web site or application program, a user may select one or more options for sharing information. For example, a user may check one or more boxes, click on one or more buttons, or otherwise provide an indication of one or more user preferences relating to sharing information. In an embodiment, the one or more user preferences may be transmitted, or obtained, via a network, to, or by, a second computing platform, such as a computing platform capable of performing one or more server functions.

With regard to box 104, information may be collected from a plurality of channels of at least partially disparate information, based at least in part on one or more user preferences, for example. In this context, channel of information is intended to refer to one or more sources of information or to one or more particular modes or manners of communication of information. Of course, such channels of information may involve one or more disparate sources or types of information. In addition, such channels of information may involve one or more disparate modes or manners of communication of information. For example, contact information from a first third party source may comprise a first channel of information. For further example, contact information from a second third party source, an application program, or a user device may comprise a second channel of information. In an embodiment, a system or process may combine similar types of information from a plurality of channels of information, such as by combining contact information from a first and second channel of information. In another embodiment, a system or process may treat similar types of information from separate channels of information separately. In addition, a system or process may treat information from a first web site as a separate channel of information from similar information from a second web site, for example. In an embodiment, the channels of information may include a variety of sources, such as traffic information, geographic information, news, interests, shopping information, user information, such as contacts and calendar information, search history information, browsing information, social networking information, and other third part sources of information, including one or more web-sites, databases, user devices, or application programs. However, it should be noted these are merely examples relating to channels of information and claimed subject matter is not limited to these examples.

In an embodiment, information may be collected, received, or obtained by a system of process in a variety of manners, such as by one or more computing platforms in conjunction with the use of one or more web crawlers, search engines, or the like. In addition, information may be collected, obtained, or received from one or more user devices, application programs, or web sites, such as in one of the manners discussed above. For example, one or more application programs executing on a user device may transmit information from a user device, via a network, to a system or process in accordance with an embodiment. For an additional example, a user may employ a web browser in conjunction with one or more web pages to transmit information from a user device, an application program, or a web site, such as a third party web site, via a network, to a system or process. In addition, a user may provide a system or process with information, such as login information, at least in part to enable the system or process to obtain information from one or more application programs, user devices, or web sites, for example.

In at least one embodiment, information may also be collected, obtained, or received by a system or process without having received one or more user preferences. For example, a system or process may include one or more default preferences for any user, so that information may be collected, such as by a computing platform, for that user without having received an indication of one or more explicit or implicit user preferences. In an embodiment, a system or process may gather information from one or more channels of at least partially disparate information, based at least in part on a default set of user preferences. For example, default preferences may include receiving one or more types of information from one or more sources, such as one or more headline news stories from a particular web site or advertised sales from one or more web sites or commercial partners associated with a system or process. Of course, these are merely a few examples relating to default preferences and claimed subject matter should not be limited in this regard.

With regard to box 106, the collected information may be parsed, such as by an application program or module executing on one or more computing platforms, based at least in part on one or more rules. In this context, parsing may mean mining, filtering, ranking or otherwise identifying one or more desirable information elements of the collected information. In an embodiment, the one or more rules may comprise one or more rules based at least in part on explicit user preferences, one or more rules based at least in part on implicit user preferences, one or more rules adapted to filter out spam, or combinations thereof, for example. One example relating to mining or filtering content may be found in U.S. patent application Ser. No. 11/130,592, entitled “Content-management system for user behavior targeting.” In this example, the one or more rules may include rules derived from the explicit user preferences. For example, a user may choose to receive one or more types of information from one or more sources of information, such as news headlines from a particular web site. A system or process, based at least in part on the user choice, may create or implement a rule to allow news headlines from the particular web site to pass through a filter, for example.

With regard to box 106, one example of parsing the collected information may comprise an alert to a user based at least in part on a user's commute pattern. In this embodiment, the alert may comprise information relating to traffic along the route, alternate routes, a user's appointment schedule, or the like. Another example may comprise a download of one or more documents from one or more internet sites based at least in part on a user's interest. In this embodiment, a user's interest may be derived based at least in part on a users browsing or searching history, for example. Yet another example may comprise a suggesting of one or more stores to buy one or more gifts based at least in part on a user's calendar of birthdays, such as birthdays for friends and family. In this embodiment, a system or process may provide a user with directions to one or more stores, such as directions based at least in part on one or more traffic patterns at one or more times during a day, for example. Of course these are merely illustrative examples related to information elements that may be parsed from the collected information and many other types of information may be similarly parsed. Accordingly, claimed subject matter is not limited in this regard.

With regard to box 108, the parsed information may be delivered from a computing platform via a network to a user device, such as a computing platform, for example. In an embodiment, the delivered information may be presented or transmitted to a user at one or more times depending at least in part on one or more user preferences, such as a time of day, a date, a geographic location associated with a user, etc. For example, an application program executing on a user device may present the delivered information based at least in part on one or more user preferences, one or more user requests, or the like.

With regard to box 110, one or more additional rules may be derived from implicit user preferences, such as one or more rules or preferences derived from user behavior. One example relating to rule derivation may be found in U.S. patent application Ser. No. 11/130,592, entitled “Content-management system for user behavior targeting.” As discussed above, one or more implicit user preferences may relate to one or more quantitative or qualitative aspects of a user's behavior. For example, a computing platform having access to a user history, such as search or browsing history from one or more web sites, application programs, or user devices, may derive one or more rules based at least in part on user behavior as shown by the user history. Examples of user behavior may include web browsing, searching, or other activities, and may include a quantitative and qualitative evaluation of the user's behavior. For example, if a user has been searching for prices on a particular product a computing platform may derive a rule to allow advertisements for that product to pass through the filter. As another example, if a user has spent a threshold amount of time with one or more activities, such as reading particular types of news, reviewing particular web sites, etc., a system or process may derive one or more rules based at least in part on the qualitative aspects of a user's behavior. For example, if a user has spent a threshold amount of time reading political news, a system may derive a rule to send updates to political news stories to the user for a determined period of time. For further example, the determined period of time and a quantity of the information delivered may depend at least in part on qualitative or quantitative aspects of the user's behavior, such as frequency of the behavior, intensity of the behavior, duration of the behavior, or similar factors.

It should be noted that, although aspects of the above system or process have been described in a particular order, the specific order is merely an example of a process and claimed subject matter is of course not limited to the order described. It should also be noted that the methods and processes described herein, may be capable of being performed by one or more computing platforms. In addition, the methods or processes described herein may be capable of being stored on a storage medium as one or more machine readable instructions, that if executed may be adapted to enable a computing platform to perform one or more actions.

“Storage medium” as referred to herein relates to media capable of maintaining expressions which may be operated on, or executed by, by one or more machines. For example, a storage medium may comprise one or more storage devices for storing machine-readable instructions or information. Such storage devices may comprise any one of several media types including, for example, magnetic, optical or semiconductor storage media. However, these are merely examples of a storage medium and claimed subject matter is not limited in these respects.

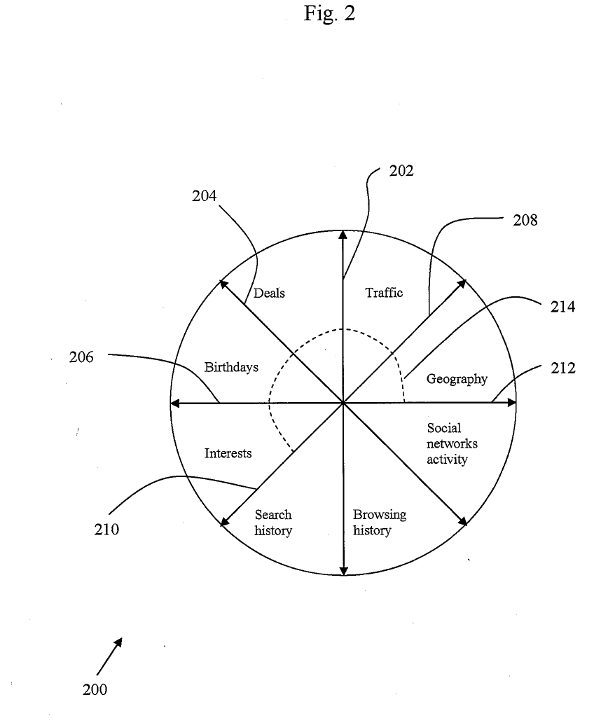

FIG. 2 is a schematic diagram of one or more channels of at least partially disparate information in accordance with an embodiment 200. In this embodiment a user may have provided a system or process with one or more user preferences. For example, a user may have provided a system or process with an indication that a user would like to receive information relating to one or more topics, such as traffic and shopping deals, represented in FIG. 2 by lines 202 and 204, respectively. In this embodiment, the user may also have specified one or more sources for traffic and shopping deals. For example, a user may have specified a first web site associated with shopping deals and a second web site associated with traffic news. Alternatively, a user may have only specified the type of information and allowed a system or process to use one or more default sources for traffic and deal information, for example. In another embodiment, a type or a source of information may be derived based at least in part on one or more user activities, for example.

In an embodiment, a user may also have chosen to share one or more types or sources of information with a system or process. For example, a user in conjunction with an application program, user device, or web site may have chosen to share information relating to one or more birthdays with a system or process, represented in FIG. 2 by line 206. In an embodiment the information relating to one or more birthdays may be associated with one or more application programs, user devices, or web sites. As discussed above, a user may have instructed one or more application programs, user devices, or web sites to transmit information related to one or more birthdays to a system or process in accordance with an embodiment. Alternatively, a user may have provided a system or process with information, such as login information, at least in part to enable the system or process to obtain information relating to one or more birthdays from one or more application programs, user devices, or web sites.

In an embodiment, a user may also have chosen to share one or more additional types or sources of information with a system or process. For example, a user, in conjunction with an application program, user device, or web site, may have chosen to share information relating to one or more geographic locations associated with a user, represented in FIG. 2 by line 208. In an embodiment the information relating to one or more geographic locations may be associated with one or more application programs or user devices. For example, a user's cell phone or other device may include Global Positioning System (GPS) functionality. In an embodiment, a user may have instructed one or more application programs or user devices to transmit geographic information associated with a user to a system or process in accordance with an embodiment. Alternatively, a user may have provided a system or process with information, such as login information, at least in part to enable the system or process to obtain information relating to geographic information associated with a user from one or more application programs or user devices. Alternatively, a user may have chosen to share less precise geographic information associated with the user. For example, a user may have chosen, using one or more application programs, user devices, or web sites, to share the user's zip code, home address, work address, commute route, a range of commute times, city, or state information with a system or process.

In an embodiment, a user may also have chosen to share one or more additional types or sources of information with a system or process. For example, a user in conjunction with an application program, user device, or web site may have chosen to share information relating to one or more interests or social network activity, represented in FIG. 2 by lines 210 and 212, respectively. In an embodiment the information relating to interests or social network activity may be associated with one or more application programs, user devices, or web sites. As discussed above, a user may have instructed one or more application programs, user devices, or web sites to transmit information related to interests or social network activity to a system or process in accordance with an embodiment. Alternatively, a user may have provided a system or process with information, such as login information, at least in part to enable the system or process to obtain information related to interests or social network activity from one or more application programs, user devices, or web sites. In an embodiment, a user may, in conjunction with one or more application programs, user devices, or web sites, alternatively have provided a system or process with explicit information relating to a user's interests or interests associated with one or more of a user's friends. For example, a user may have selected one or more options in an application program, user device, or on a web site as representative of a user's interests or of interests associated with a user's friend. In addition, a user may have instructed the application program, user device, or web site to transmit the selected options to a system or process in accordance with an embodiment.

A graphical representation of a relationship at a particular time between the one or more at least partially disparate channels of information shown in FIG. 2 may be represented by dashed line 214. In an embodiment, dashed lined 214 represents a relationship between information channels 202, 204, 206, 208, 210, and 212 at a particular range of times or dates. For example, with regard to the intersection between information channel 206 and dashed line 214, a system or process may recognize that a user's friend has a birthday coming up and that the user may have requested a reminder of this birthday. In addition, based at least in part on information channels 202, 204, 208, 210, and 212, a system or process may determine one or more recommendations for a user. For example, based at least in part on information channels 210 or 212, a system or process may have access to information relating to a user's friend's interests. Based at least in part on a user's friend's interests, a system or process may search for available deals of sales, or parse available deals or sales information, for one or more products relating to the user's friends interests in conjunction with information channel 204.

In addition, based at least in part on geographic information relating to a user, as represented by information channel 212, a system or process may search for or parse deals or sales to those in a geographically similar area as a user's location, such as those within a certain distance of the user's location, for example. Furthermore, based at least in part on traffic information from information channel 208, such as real-time, near real-time, or relatively real-time traffic updates, in conjunction with geographic information relating to a user, a system or process may further parse deal or sale information to those with favorable traffic patterns or shorter travel times relative to a user's geographic information, for example. In an embodiment, a system or process may then transmit the deal or sale info, which has been parsed based at least in part on birthdays, interests, social network activity, geography, and traffic, to a user. In this way a user may be presented with more useful or customized information in a timely manner. For example, a user may review the transmitted deal or sale information and determine which, if any of the deals or sales, are of particular interest to the user. It should, however, be noted that this is merely one example relating to a system or process parsing information from one or more channels of at least partially disparate information and that claimed subject matter is of course not limited in this regard.

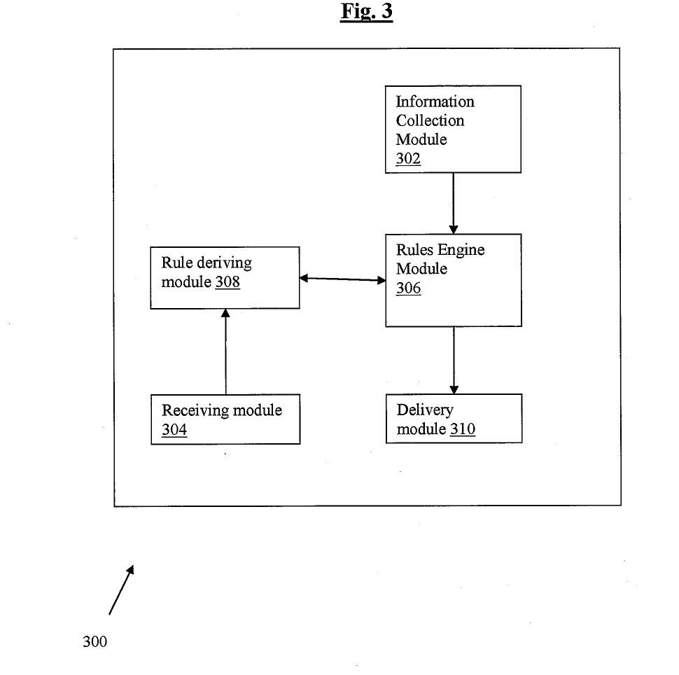

FIG. 3 is a schematic diagram of a system or apparatus in accordance with an embodiment 300. With regard to embodiment 300, an information retrieval and parsing process, system or apparatus may comprise an application program capable of being executed by one or more computing platforms. An application program in accordance with an embodiment may comprise one or more modules adapted for performing one or more tasks or functions. For example, a module may comprise one or more instructions or data that, if executed or operated on, by a computing platform, may be adapted to enable a computing platform to perform one or more functions. For example, embodiment 300 may include an information collection module 302. In an embodiment, information collection module 302 may enable a computing platform to collect, obtain, or receive information from one or more channels of at least partially disparate information. For example, information collection module 302 may, as discussed above with regard to FIG. 1, enable a computing platform to obtain or receive information that a user has chosen to share with embodiment 300, such as information from one or more application programs, web sites, or computing platforms associated with a user. In this embodiment, one or more computing platforms associated with a user may include mobile devices, Personal Digital Assistants, cellular phones, media players, personal computers, or the like, such as in conjunction with receiving module 304, for example, Furthermore, information collection module 302 may further enable a computing platform, at least in part in conjunction with receiving module 304, to obtain, collect, or receive information from one or more additional channels of information, such as via one more web sites, one or more news sites, one or more weather sites, one or more retail sites, one or more web crawlers, or one or more search engines, or other modes or manners of communication, such as cell phone signals, radio or television signals, to name but a few examples. Information collection module 302 may further enable a computing platform to store at least a portion of the received information from the one or more channels of information, such as at a storage device coupled to the computing platform, for example.

Embodiment 300 may further include a rules engine module 306. In an embodiment, rules engine module 306 may enable a computing platform to parse the information collected or stored by information collection module 302. For example, rules engine module 306 may include one or more rules, such as one or more rules based at least in part on one or more user preferences, such as one or more explicit or implicit user preferences, as discussed above. In one embodiment, a user may specify one or more channels of information for sharing with rules engine module 306, such as information from one or more computing platforms, user devices, application programs or web sites, for example. Such channels of information may include a user profile, a user calendar, one or more user contacts, a user search history, a user browsing history, a user shopping history, a user movie rental history, social networking information, or the like, any of which may be associated with one or more channels of information. Embodiment 300 may be executed on a computing platform to parse the received, collected, or obtained information from the one or more channels of at least partially disparate information based at least in part on received explicit or implicit user preferences, as discussed above with regard to FIGS. 1 and 2. In addition, embodiment 300 may enable a computing platform to filter the received information based at least in part on one or more spam rules or filters, such as rules set by a service provider or a user, for example, to filter out unwanted commercial advertisements.

Embodiment 300 may further comprise a rule deriving module 308. Rule deriving module 308 may enable a computing platform to derive one or more rules based at least in part on one or more aspects of a user's behavior, for example. In an embodiment, the one or more aspects of a user's behavior may comprise qualitative and quantitative aspects of a user's behavior, as described above with regard to FIGS. 1 and 2. For example, rule deriving module 308 may enable a computing platform to derive one or more rules based at least in part on how often a user performs a certain activity. For example, if a user reads news articles of a particular type more than a threshold number of times during a time period, then rule deriving module 308 may derive a rule that the user is interested in news articles of that particular type and allow articles of a similar or a same type to pass through a filter. For additional example, rule deriving module 308, may enable a computing platform to derive one or more rules based on how intently a user performs a certain activity. For example, if a user has been intently reading reviews of one or more types of products and a user has chosen to share that information with embodiment 300, rule deriving module 308 may enable a computing platform to derive a rule that the user is interested in advertisements for the one or more types of products and allow those advertisements to pass through a filter. Embodiment 300 may further comprise a delivery module 310. Delivery module 310 may enable a computing platform to transfer the filtered received information to a user, such as by transferring the information to a user device via a network, for example.

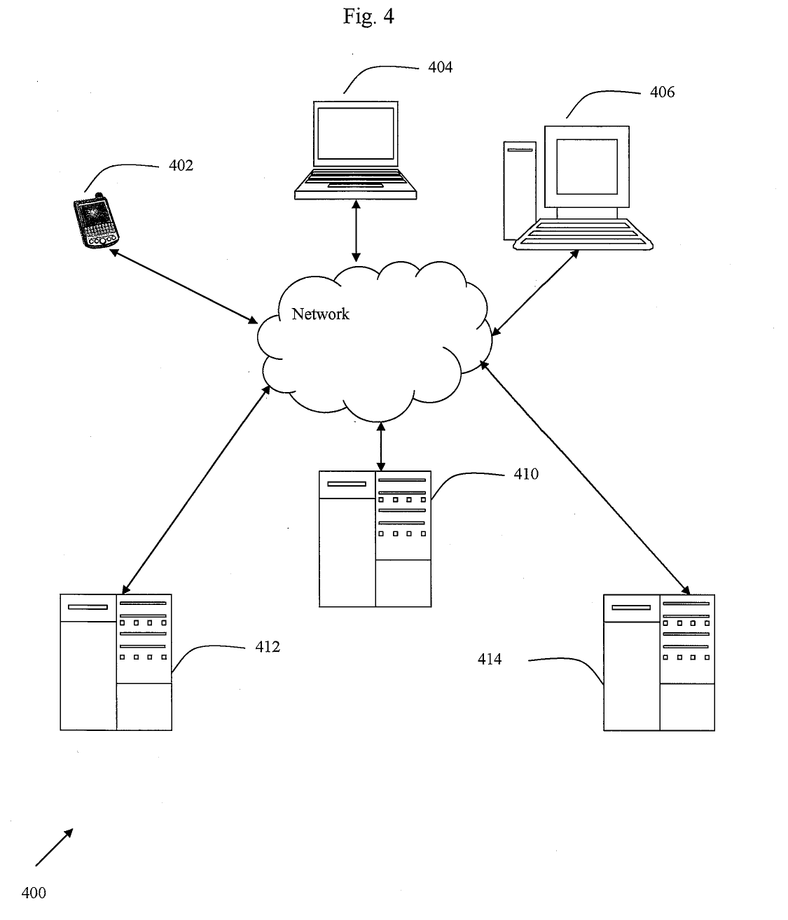

FIG. 4 is a schematic diagram of a system in accordance with an embodiment 400. With regard to an embodiment 400, a computing platform, such as one or more of computing platforms 402, 404, or 406 may be in communication with one or more other computing platforms, such as computing platforms 410, 412, or 414, for example. In an embodiment, computing platforms 402, 404, or 406 may include one or more application programs for communicating with computing platforms 410, 412, or 414, such as via a network and one or more communication adapters (not shown). For example, a user may employ computing platforms 402, 404, 406, or a combination thereof to convey one or more preferences to computing platform 410, 412, or 414 via a network. In an embodiment, the user may indicate preferences by selecting one or more options in a user interface, such as an application program or website, for example. In this embodiment, the user may specify one or more desired types or categories of information, such as specifying that the user would like to receive news information relating to one or more areas or topics. The one or more areas or topics may include specific topics, news specific to a geographic region, news specific to a particular company or industry, or the like.

In addition, the user may specify one or more types of information to share with computing platform 410, 412, or 414, such as any of the shared information discussed above. For example, a user may choose to share information relating to the user's contacts, the user's calendar, the user's browsing history, the user's searching history, the user's shopping history, user movie rental history, user interests, user commute patterns, user social network information or activity, user geographic information, or the like, any of which may be associated with one or more at least partially disparate channels of information. The user preferences may be transmitted to computing platforms 410, 412, or 414 via a network for use, at least in part, by a system or process, such as those described above with regard to FIGS. 1-3, for example. In an embodiment, the user preferences may, at least in part, be used as one or more rules, or used to derive one or more rules, for an application program or module, such as rules engine module 306 or rule deriving module 308, for example. In this embodiment, a computing platform may collect, obtain, or receive information from one or more channels of at least partially disparate information based, at least in part, on one or more received user preferences. For example, computing platform 410 may employ an application program or module, such as information collection module 302, at least in part to collect, obtain, or receive information from one or more channels of information based at least in part on one or more user preferences. Furthermore, a computing platform, such as computing platform 410, may parse the collected information based at least in part on one or more explicit or implicit user preferences, or one or more rules derived from explicit or implicit user preferences, such as by using rules engine module 306 to parse out information that does not meet one or more rules. For example, computing platform 410 may parse out information that does not satisfy one or more user defined rules or one or more rules derived from one or more explicit or implicit user preferences, for example. A computing platform may then transmit the parsed information, such as by using a delivery module 310, to a user device, such as computing platforms 402, 404, or 406, for example, for presentation to a user at one or more times. In an embodiment, the one or more times may be based on explicit user preferences, implicit user preferences, default user preferences, or a user request, for example.

It should be noted, that though described with regard to particular computing platforms performing one or more functions, an apparatus, system or process in accordance with an embodiment may be capable of being executed by, and corresponding functions may be performed on, one or more computing platforms. For example, in at least one embodiment a rules engine module, a rules deriving module, an information collecting module, a delivery module, a receiving module, or the like may be hosted on one or more computing platforms. Some modules may be hosted on a computing platform, such as a server, while other modules may be hosted on another computing platform, such as a client or a mobile device, or combinations thereof, for example. Accordingly, claimed subject matter is not limited in this regard.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
collecting information from a plurality of channels of at least partially disparate information, said plurality of channels being based at least in part on a set of user preferences;
parsing the collected information based at least in part on one or more rules, said one or more rules based at least in part on said set of user preferences.

2. The method of claim 1, and further comprising: receiving said set of user preferences.

3. The method of claim 1, and further comprising: delivering one or more recommendations to a user device based at least in part on the parsed information.

4. The method of claim 1, wherein parsing the collected information comprises mining a desirable information element from the collected information.

5. The method of claim 1, wherein parsing the collected information comprises filtering a desirable information element from the collected information.

6. The method of claim 1, wherein parsing the collected information comprises ranking a desirable information element from the collected information.

7. The method of claim 1, and further comprising: receiving a user reaction to the parsed information at least in part to refine subsequent parsing.

8. The method of claim 1 and further comprising: delivering additional recommendations at one or more times

9. The method of claim 1, and further comprising: delivering additional recommendations without receiving a user request.

10. The method of claim 1, and further comprising: determining a quantity of recommendations based at least in part on the one or more user preferences.

11. The method of claim 1, and further comprising: deriving one or more additional rules for parsing based at least in part on one or more user behaviors.

12. The method of claim 11, wherein said one or more user behaviors comprise implicit user preferences.

13. The method of claim 11, wherein said one or more user behaviors comprise at least a history or recent user behavior and a qualitative measure of recent user behavior.

14. The method of claim 2, wherein said one or more recommendations are based at least in part on time.

15. The method of claim 2, wherein said one or more recommendations are based at least in part on a geographic location of a user or a geographic location of a user's social network.

16. The method of claim 3, wherein said user device comprises a computing platform.

17. The method of claim 16, wherein said computing platform comprises a mobile device.

18. The method of claim 1, wherein said plurality of channels of information comprise at least one of the following: weather data; traffic data; map data; news data; e-mail data; messaging data; calendar data; contacts data; social networking data; shopping data; search engine history data; browsing history data; time data, blog data, and third party data.

19. An article comprising: a storage medium having instructions stored thereon, wherein said instructions, if executed by a computing platform, enable said computing platform to:
collect information from a plurality of channels of at least partially disparate information, said plurality of channels being based at least in part on a set of user preferences;
parse the collected information based at least in part on one or more rules, said one or more rules based at least in part on said set of user preferences.

20. The article of claim 19, wherein said instructions, if executed by a computing platform, further enable said computing platform to receive said set of user preferences.

21. The article of claim 19, wherein said instructions, if executed by a computing platform, further enable said computing platform to deliver one or more recommendations to a user device based at least in part on the parsed information.

22. The article of claim 19, wherein parsing the collected information comprises mining a desirable information element from the collected information.

23. The article of claim 19, wherein parsing the collected information comprises filtering a desirable information element from the collected information.

24. The article of claim 19, wherein parsing the collected information comprises ranking a desirable information element from the collected information.

25. The article of claim 19, wherein said instructions, if executed by a computing platform, further enable said computing platform to receive a user reaction to the parsed information at least in part to refine subsequent parsing.

26. The article of claim 19, wherein said instructions, if executed by a computing platform, further enable said computing platform to deliver additional recommendations at one or more times

27. The article of claim 19, wherein said instructions, if executed by a computing platform, further enable said computing platform to deliver additional recommendations without receiving a user request.

28. The article of claim 19, wherein said instructions, if executed by a computing platform, further enable said computing platform to determine a quantity of recommendations based at least in part on the one or more user preferences.

29. The article of claim 19, wherein said instructions, if executed by a computing platform, further enable said computing platform to derive one or more additional rules for parsing based at least in part on one or more user behaviors.

30. The article of claim 29, wherein said one or more user behaviors comprise implicit user preferences.

31. The article of claim 29, wherein said one or more user behaviors comprise at least a history or recent user behavior and a qualitative measure of recent user behavior.

32. The article of claim 21, wherein said user device comprises a computing platform.

33. The article of claim 32, wherein said computing platform comprises a mobile device.

34. The article of claim 19, wherein said plurality of channels of information comprise at least one of the following: weather data; traffic data; map data; news data; e-mail data; messaging data; calendar data; contacts data; social networking data; shopping data; search engine history data; browsing history data; time data, blog data, and third party data.

35. A system comprising:
a computing platform adapted to collect information from a plurality of channels of at least partially disparate information, said plurality of channels being based at least in part on a set of user preferences;
said computing platform further adapted to parse the collected information based at least in part on one or more rules, said one or more rules based at least in part on said set of user preferences.

36. The system of claim 35, wherein said computing platform is further adapted to receive said set of user preferences.

37. The system of claim 35, wherein said computing platform is further adapted to deliver one or more recommendations to a user device based at least in part on the parsed information.

38. The system of claim 35, wherein parsing the collected information comprises mining a desirable information element from the collected information.

39. The system of claim 35, wherein parsing the collected information comprises filtering a desirable information element from the collected information.

40. The system of claim 35, wherein parsing the collected information comprises ranking a desirable information element from the collected information.

41. The system of claim 35, wherein said computing platform is further adapted to receive a user reaction to the parsed information at least in part to refine subsequent parsing.

42. The system of claim 35, wherein said computing platform is further adapted to deliver additional recommendations at one or more times

43. The system of claim 35, wherein said computing platform is further adapted to deliver additional recommendations without receiving a user request.

44. The system of claim 35, wherein said computing platform is further adapted to determine a quantity of recommendations based at least in part on the one or more user preferences.

45. The system of claim 35, wherein said computing platform is further adapted to derive one or more additional rules for parsing based on one or more user behaviors.

46. The system of claim 45, wherein said one or more user behaviors comprise implicit user preferences.

47. The system of claim 45, wherein said one or more user behaviors comprise at least a history or recent user behavior and a qualitative measure of recent user behavior.

48. An apparatus comprising:
a user device adapted to collect one or more user preferences;
said user device further adapted to receive information parsed based at least in part on one or more rules, said information having been collected from a plurality of channels of at least partially disparate information, said one or more rules based at least in part on the collected one or more user preferences.

49. The apparatus of claim 48, wherein said user device is further adapted to transmit said one or more user preferences to a computing platform.

50. The apparatus of claim 48, wherein said user device is further adapted to display the received information to a user.

51. The apparatus of claim 48, wherein said user device is further adapted to transmit a record of one or more user behaviors to a computing platform.

52. The apparatus of claim 51, wherein said one or more user behaviors comprise implicit user preferences.

53. The apparatus of claim 51, wherein said one or more user behaviors comprise at least a history or recent user behavior and a qualitative measure of recent user behavior.

54. The apparatus of claim 48, wherein said user device comprises a mobile device.
